(19) United States
(12) Patent Application Publication
(10) Pub. No.: US 2003/0121731 A1
(43) Pub. Date: Jul. 3, 2003

(54) Integrated speed sensor for elevator application

(75) Inventors: A. John Santos, Farmington, CT (US); Mark E. LaCroix, New Hartford, CT (US)

Correspondence Address: MICHAEL BEST & FRIEDRICH LLP, 3773 CORPORATE PARKWAY, SUITE 360, CENTER VALLEY, PA, 18034-8217, US

(73) Assignee: The Torrington Company, Torrington, CT

(21) Appl. No.: 10/042,884

(22) Filed: Jan. 3, 2002

(51) Int. Cl. B66B 1/34

(52) U.S. Cl. 187/391

(57) ABSTRACT

A bearing encoder is used with two or three Hall effect sensors. One sensor is used to provide a high resolution quadrature signal for speed control, and the other sensor or sensors provide a low resolution signal that may be used as a rescue encoder quadrature signal and/or an ANSI speedcheck encoder signal. The device is suitable for elevator control.

### FIELD OF THE INVENTION

This invention pertains to the field of elevator control, and in particular, to an integrated speed sensor using a bearing encoder.

### BACKGROUND OF THE INVENTION

Elevators may require up to three different speed feedback signals: (1) a high resolution quadrature motor speed control feedback (main encoder), (2) a low resolution quadrature rescue encoder (rescue encoder), and a low resolution single track ANSI speedcheck encoder (ANSI encoder). Providing these three signals requires either three separate encoders mounted on a shaft of the machine, or a combination of a multiple track encoder and a third sensor designed to provide the rescue functionality. The encoders can take up to 40 mm of space at the end of the machine. This space is preferably used for machine adjustment, so it is desirable to eliminate the need for the encoders. Another reason for eliminating encoders is that encoders have proven to be the weak link in elevator control systems because they require coupling to the elevator motor shaft.

### SUMMARY OF THE INVENTION

Briefly stated, an integrated sensor for an elevator includes a bearing encoder with two or three Hall effect sensors on the encoder. One sensor is used to provide a high resolution quadrature signal for speed control, with the other sensors providing a low resolution signal that is used for a rescue encoder quadrature signal and an ANSI speedcheck encoder signal.

According to an embodiment of the invention, an integrated sensor for an elevator includes a bearing encoder; first and second Hall effect sensors on the encoder; wherein an output of the first sensor is a high resolution quadrature signal and an output of the second sensor is a low resolution signal.

### BRIEF DESCRIPTION OF THE DRAWINGS

FIG. 1 shows an end view of a prior art bearing encoder;

FIG. 2 shows an end view of a bearing encoder according to an embodiment of the present invention; and

FIG. 3 shows a perspective view of the encoder of FIG. 2.

### DETAILED DESCRIPTION OF THE PREFERRED EMBODIMENT

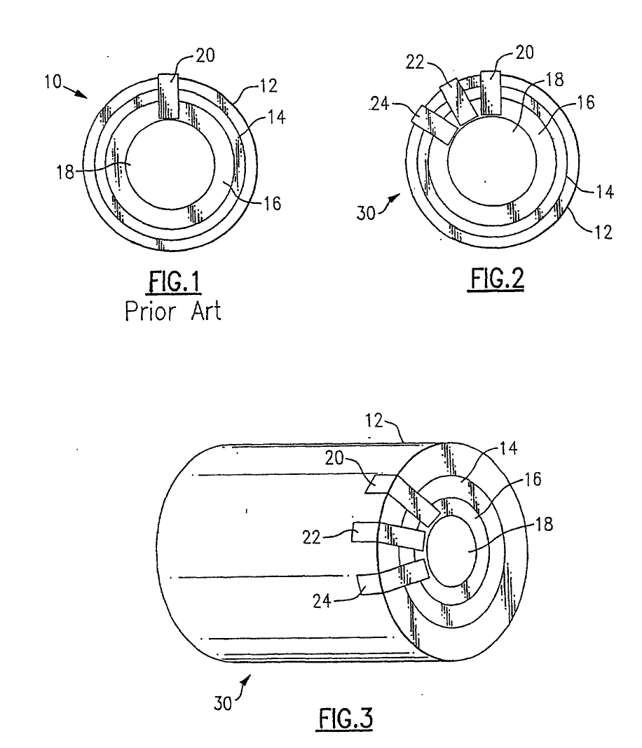

Referring to FIG. 1, a high resolution magnetic sensor such as a bearing encoder 10 includes an outer bearing casing 12 and an inner race 16 that fit around a shaft 18. A magnetic ring 14, attached to inner race 16, is subdivided into a plurality of north and south magnetic poles. Inner ring 14 and inner race 16 move with shaft 18, while a Hall effect sensor 20 remains stationary. Sensor 20 detects the changing magnetic fields caused by the rotation of ring 14 and provides an output. In one form of bearing encoder, the output is conditioned by electronics and sent directly to a control processor. The pulses per revolution (PPR) of bearing encoder 10 is equal to the number of north-south-magnetic poles in ring 14. In another form of bearing encoder, the output is processed by some other means and a high resolution output is produced, such as 4,096 PPR. High resolution magnetic sensors are known to be manufactured by Heidenheim, SKF, and Torrington. Such a sensor would be used to provide motor speed control feedback for a drive motor for an elevator.

Referring to FIGS. 2-3, a bearing encoder 30 includes second and third sensors 22 and 24, which operate the same way as sensor 20. Such a bearing encoder has applicability to the elevator industry because of the need for a rescue encoder and an ANSI speedcheck encoder. The rescue encoder is used by a mechanic as a visual check of the speed of the elevator car during a rescue operation. Since the rescue encoder signal is not used for controlling the elevator car, it does not need to be a high resolution signal, but it needs to be a quadrature signal for direction sensing. The ANSI speedcheck encoder provides an independent speed check and is required by code in North America. This signal is also a low resolution signal, but only has to be a single track signal. Since it is not used for controlling the elevator car, it does not need to be a high resolution signal. Using two sensors makes it possible to obtain quadrature signals.

The sensor output can be processed in one of two ways. In the first way, the output is conditioned by electronics and sent directly to the elevator system's control processor. The number of pulses per revolution equals the number of north-south magnetic pole pairs. In the second way, the output is processed to obtain a high resolution signal, such as the 4,096 pulses per revolution described above.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. An integrated sensor for an elevator, comprising:
a bearing encoder;
first and second Hall effect sensors on said encoder;
wherein an output of said first sensor is a high resolution quadrature signal and an output of said second sensor is a low resolution signal.

2. An integrated sensor according to claim 1, further comprising a third Hall effect sensor on said encoder, wherein an output of said third sensor is a low resolution quadrature signal.
